(19) United States
(12) Patent Application Publication
(10) Pub. No.: US 2015/0100347 A1
(43) Pub. Date: Apr. 9, 2015

(54) UNIVERSAL ONLINE HEALTHCARE MARKETPLACE

(71) Applicant: Shivprasad Nikam, Jenkins Township, PA (US)

(72) Inventor: Shivprasad Nikam, Jenkins Township, PA (US)

(21) Appl. No.: 14/046,102

(22) Filed: Oct. 4, 2013

(51) Int. Cl. G06F 19/00

(52) U.S. Cl. CPC G06F 19/322
USPC 705/3

(57) ABSTRACT

A cloud-based medical records management network permits a user to control access to the user's medical records, and at the same time permits medical providers on the network to advertise and provide access to services within the same network. The system may allow for commercial transactions between users and medical providers online.

### BACKGROUND OF THE INVENTION

1. Field of the Invention

The invention is directed to an online universal healthcare marketplace, incorporating a cloud-based medical records management system which permits a user to control access to his or her own medical records, and at the same time provides a platform within which medical providers and other vendors can advertise and provide access to services within the same network.

2. Description of the Related Art

Current methods of storing patients' medical information allow management of the records by healthcare providers, health plans and healthcare institutions. The information is not owned by patients. Although government regulations in the United States including the Health Insurance Portability and Accountability Act (“HIPAA”) require stringent measures to ensure privacy of the information, the portability of individual healthcare information has suffered because portability of information is not in the business interests of the entities who currently own and administer the healthcare information.

This lack of meaningful portability has resulted in compartmentalization and monopolization of health services in geographically restricted areas. Patients are deprived of second opinions and lower cost options. This isolates healthcare from free market forces, artificially inflating costs and allows monopolization.

The Internet revolution has allowed universal access to services in all sorts of fields in the ever shrinking world, across national and geographic borders. The current problem of healthcare expenses that plagues the U.S. economy is largely due to inflated health costs in the U.S. healthcare system.

A universal online healthcare marketplace can and will expose healthcare to forces of the free market. This, in turn, will allow competition amongst providers of healthcare services not just in the United States but across the world. Thus, an object of the invention is to promote a more competitive pricing of healthcare services universally. Such a system will allow patients across the world to access healthcare options in geographically distant locations, allow them to compare prices and choose providers across the globe, in a manner not achievable currently.

Meaningful portability of healthcare information is at the heart of such a marketplace. Meaningful portability of healthcare information is only possible if the patient is the owner of information with unrestricted access to it. Thus another object of the universal healthcare marketplace according to the invention is to provide a common platform for those seeking healthcare and those providing the same, to allow storage, dissemination and analysis of healthcare information between patients and providers across geographically distant areas and at competitive prices. Healthcare providers with the highest quality of service and competitive pricing will be able to attract patient clients from distant geographic areas that were previously not approachable.

### Description of the Related Art

Computerized systems for the maintenance and transmission of patient medical records have been proposed and developed over the years, including some which purport to be controlled by the patient. However, true patient control of the records has proven to be elusive. The Health Insurance Portability and Accountability Act (“HIPAA”) provides for individual patient access to medical records. However, the reality is that electronic exchange of medical records under these laws and related regulations is inhibited by the privacy compliance efforts of the health provider organizations that enter, compile and maintain the medical records as well as economic disincentives to cooperation between health care professionals. When a patient wants his or her medical records released by the hospital that collected it, the patient must satisfy the HIPAA compliant requirements instituted by that organization. This usually takes the form of a release by the patient. And when one health care provider or organization transmits health care information to another, at least one of them bears the cost and the potential risk of HIPAA non-compliance. However, the patient is immune from the privacy requirement with respect to his or her own records and is free under these laws to disclose the information to anyone he or she wishes.

At the same time, privacy concerns have limited the access to electronic medical records management systems by medical providers, such as physicians and hospitals, even when the patient wants to have the records searched and displayed to such third parties, because these networks are not set up for direct communication from a physician to a patient, again, mainly as a result of privacy legislation. Relatively few medical services are transacted online, and in no case is a network provided in which medical services may be transacted on the same network where a patient's medical records are maintained.

Published International Application No. WO 02/03308 is an example of a proposed system in which patient medical records might be maintained and accessed in encrypted format on the Internet. Clearly absent from the proposed network is an open line from the medical provider to the user.

US Patent Application Publication 2004/0172307, for example, describes what purports to be an internet-based, patient-centric and patient controlled electronic medical records system and methods for managing medical records. The system disclosed in this publication does not provide a platform from which transactions between users and providers of medical services may be completed.

WO 2013/033013 purports to provide a method for advertising, compliant with government regulations such as HIPPA and the HITECH Act, to patients and other individuals, which permits searching by a health provider of patient medical records criteria without disclosing any user-specific patient information to the health provider. Although the application allows for a provider to target advertising to a user, a two-way relationship between a user and a provider is prohibited by definition.

WO 2013/003949 provides a method and system for authorizing third party access to patient health information.

None of the foregoing disclosures begins with user management of the user's own medical records. It turns out that shifting the costs and burden of HIPAA compliance to the user is key to establishing a network in which both users and providers can be included. The current format of ownership of a patient's medical information by hospitals or healthcare organizations attempts to protect privacy, but provides very little to promote meaningful portability or easy access by patients. Ownership of one's own online medical information is instrumental to getting the full benefits of portability while still protecting privacy.

### SUMMARY OF THE INVENTION

Thus, to overcome the deficiencies of the prior art and to achieve the objects of the invention, the present invention in one aspect is a cloud-based medical records management system accessible by users and medical providers, comprising: a medical records database stored on a computer readable medium containing a user's medical records data uploaded by a user or by a third party authorized by the user; and a provider information database stored on a computer readable medium containing provider services information (and in some cases tools) uploaded by a health care provider. An authorization module accessible by a user's computer enables a user to grant access to the user's medical records data to an authorized provider, and enables a user to permit third parties to upload a user's medical records data. The system provides a viewing tool with which a user or authorized medical provider may sort, format and perform statistical analysis on a user's medical records data. The system comprises a communication module enabling conversations between providers and users. The system is designed so that the provider information database may be made accessible to and searchable by a user through a user interface and a user's medical records data may be made accessible to and searchable by the user through a user interface and to an authorized provider through a provider interface.

### BRIEF DESCRIPTION OF THE DRAWINGS

FIG. 1 schematically depicts the features of the system network according to the invention.

FIG. 2 schematically depicts data analysis according to the invention.

FIG. 3 schematically depicts the de-identification of medical information in the cloud according to an aspect of the invention.

FIG. 4 schematically depicts a marketing platform according to an aspect of the invention.

### DETAILED DESCRIPTION OF THE INVENTION

A central feature of the system according to the invention is a medical records database 100 stored on a computer readable medium containing a user's medical records data uploaded by the user, or by a third party authorized by the user. Medical records includes, on one hand, information of a type typically maintained at a physician's office, such as check-up summaries, vaccinations charts, office visit summaries, laboratory results and prescriptions. Medical records also includes digitized records such as digitized x-rays, magnetic resonance imaging (MRIs) images, electrocardiograms (EKGs), CT scans, and ultra-sounds. The database 100 is “cloud-based,” which refers to distributed computing over a network which allows the running of one or more programs on many connected computers at the same time. “Cloud computing” as used herein, and as commonly used, refers to network-based services which appear to be provided by real server hardware, which in fact are served up by virtual hardware, simulated by software running on one or more computers. Thus “computer readable medium” as used herein includes virtual servers that do not physically exist which can be moved and scaled up or down in accordance with cloud computing practices well known in the art. Cloud based storage allows a large volume of data storage, universally accessible by a variety of internet-enabled digital devices, providing a central hub for data storage, processing, analysis and distribution.

Standards have been developed related to electronic medical records which improves interoperability and integrity of the medical records available for digital transmission, including in the United States Health Level Seven (HL 7), the American Society for Testing and Methods (ASTM E31) and in Europe the European Committee for Standardization (CEN TC 215). Preferably, the medical records maintained in the medical records database are compatible with one or more such standards. Preferably, the different types of information available to a user or provider from the user's medical records database are presented in a standard graphical format, which may be manipulated with tools within certain system-defined limits according to the user's preferences.

Uploading is generally through a web-based Graphical User Interface (GUI), which may be run on a personal computer, smart phone, or other internet-enabled device. As used herein, “computer” is used broadly to refer to any such internet-enabled device. Uploading is conducted differently depending on who enters the data. When a user initially enters the website, the system displays a home page, at which the user can enter either enter log in information or enter sign up information to obtain log-in credentials.

To sign up as a user initially, the user enters identity and billing information. Privacy clearances and payment typically are elicited from the user at this time. Computerized forms for performing sign up are well known in the art and need not be elaborated upon herein. At the end of this process, a user is provided with log-in information.

If log-in information is provided when the user enters the website, the user is prompted through a series of graphical displays which prompt the user to enter medical records in a variety of formats. Preferably, medical records uploaded, maintained and transmitted on the network are encrypted.

When a third party initially enters the website, the system asks for login information. To upload medical records data as a third party requires different log-in information provided to the third party by a user. The proper functioning of the method and system requires consent management and validation for third parties uploading information as well as for third parties seeking the user's permission to search and use the user's medical records, collectively referred to herein as the “authorization module.”

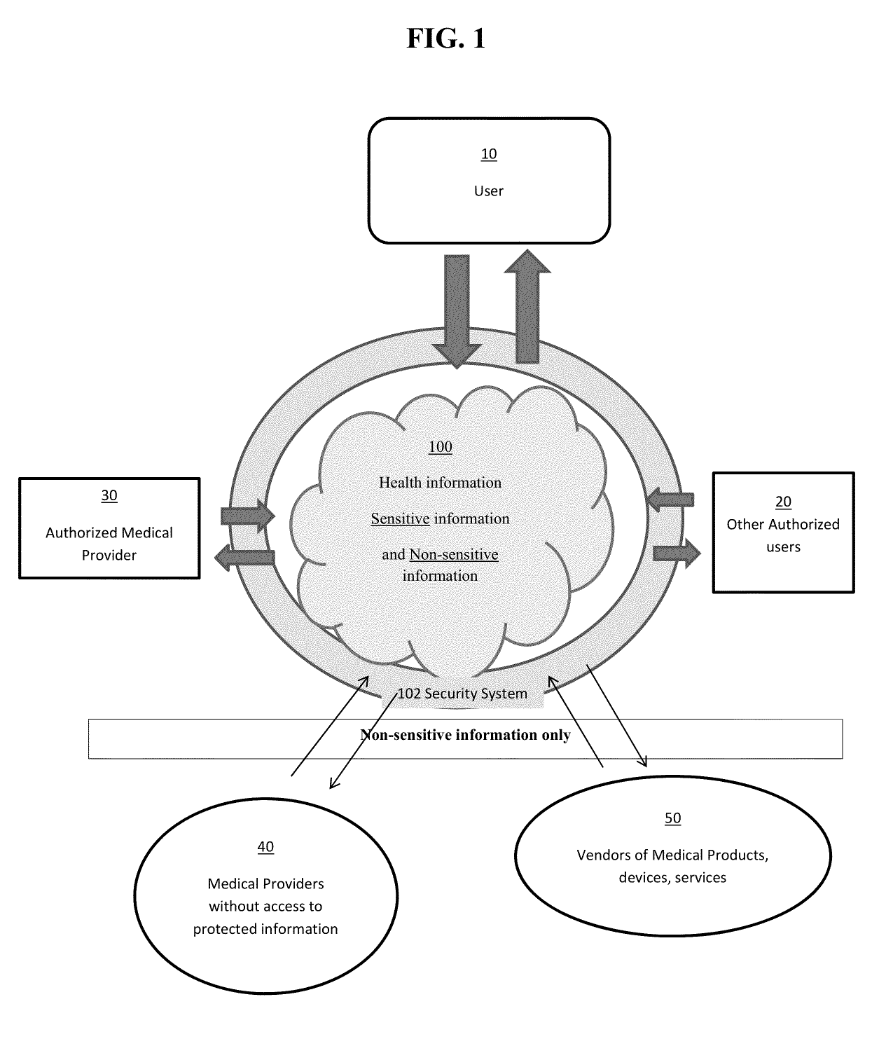

FIG. 1 schematically depicts two way communication between different types of user 10, 20, 30, 40 and 50, and a cloud-based database 100 containing sensitive information (to which the user may restrict access) and non-sensitive information (which may be provided by the third parties or by the user without restrictions or requirement for authorization). Security system 102 will identify information as either sensitive or non-sensitive and permit or deny access to same based on a comparison of credentials entered by a user of the network. In addition to the user 10, the network includes medical providers 30 authorized by the user, other authorized users 20 authorized by the patient (which might include, for example, friends and family members). Still within the network, but having access only to non-sensitive information are non-authorized medical providers 50 and vendors 60.

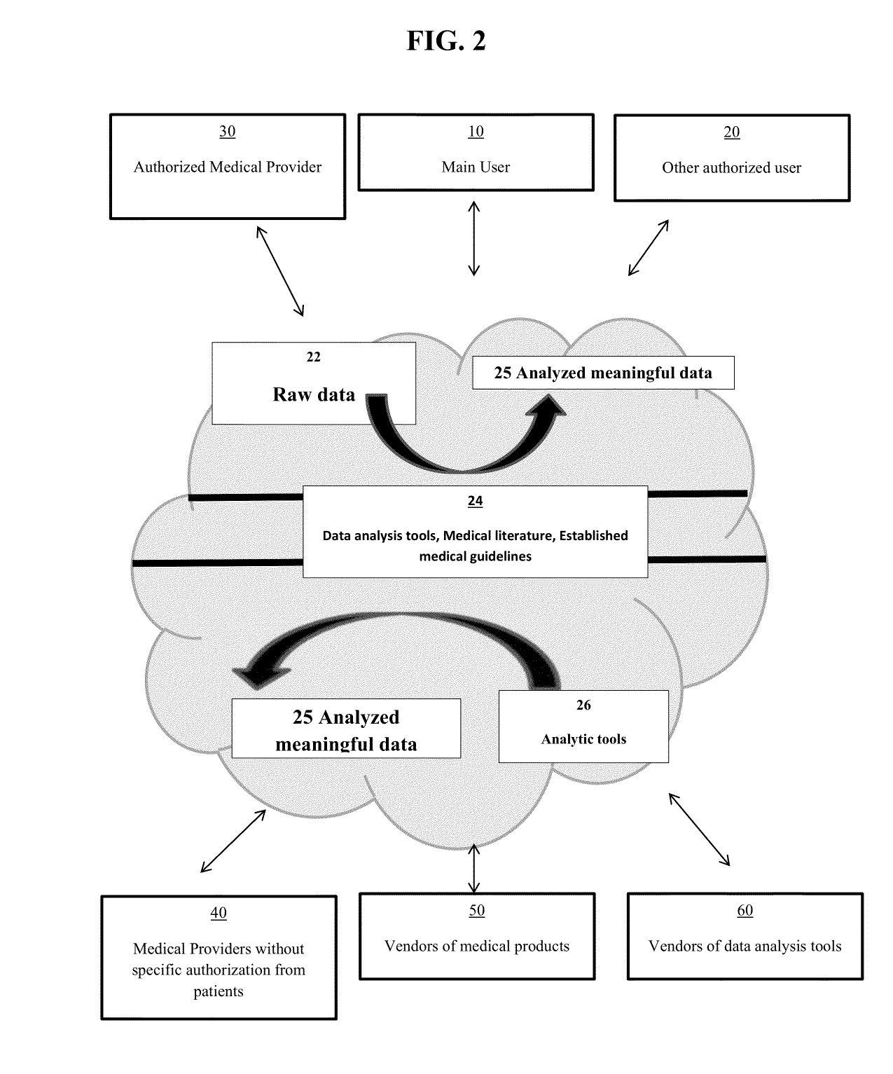

As depicted in the data analysis graphic of FIG. 2, authorized users 10, 20, and 30 and users without specific authorization, including general medical providers 40, vendors of medical products 50 and vendors of data analysis tools 60 may take advantage of the cloud-based data analysis tools 24. Thus, the data analysis tools 26, medical literature databases and medical guidelines information maintained within database 100 may receive as inputs sensitive raw data 22 and process the data to produce meaningful results sets 25. The same tools, utilizing the same database sets, may also produce meaningful analyzed data from non-sensitive queries submitted by parties without specific authorization.

The authorization module is adapted so that the user can provide authorization to authorized medical providers 30, such as doctors and hospitals, and also to other authorized users 20, such as a patient's family and friends, to provide them with credentialed restricted access to the database 100 through security system 102, which is a part of the authorization module. The patient has at all times unrestricted access to his or her sensitive and non-sensitive information. Through the process of identifying sensitive and non-sensitive information and discriminating authorized from non-authorized users, the authorization module provides non-specifically authorized users to 40, 50 to access to non-sensitive information only, to vend products and services. The authorization module is accessible by a user's computer enabling a user to grant access to the user's medical records data to an authorized provider, and enabling a user to permit third parties to upload a user's medical records data. Thus, according to the invention, users establish privacy preferences to direct which third parties have access to their account information and under what circumstances. Protocols are known in the art for supporting the dynamic creation, management and enforcement of user privacy policies through access control mechanisms, such as OASIS XACML protocol, but other access request protocols may also be employed. Whatever protocol is used, the end result is that a user may obtain login information so that third parties may be granted access to the user's medical records.

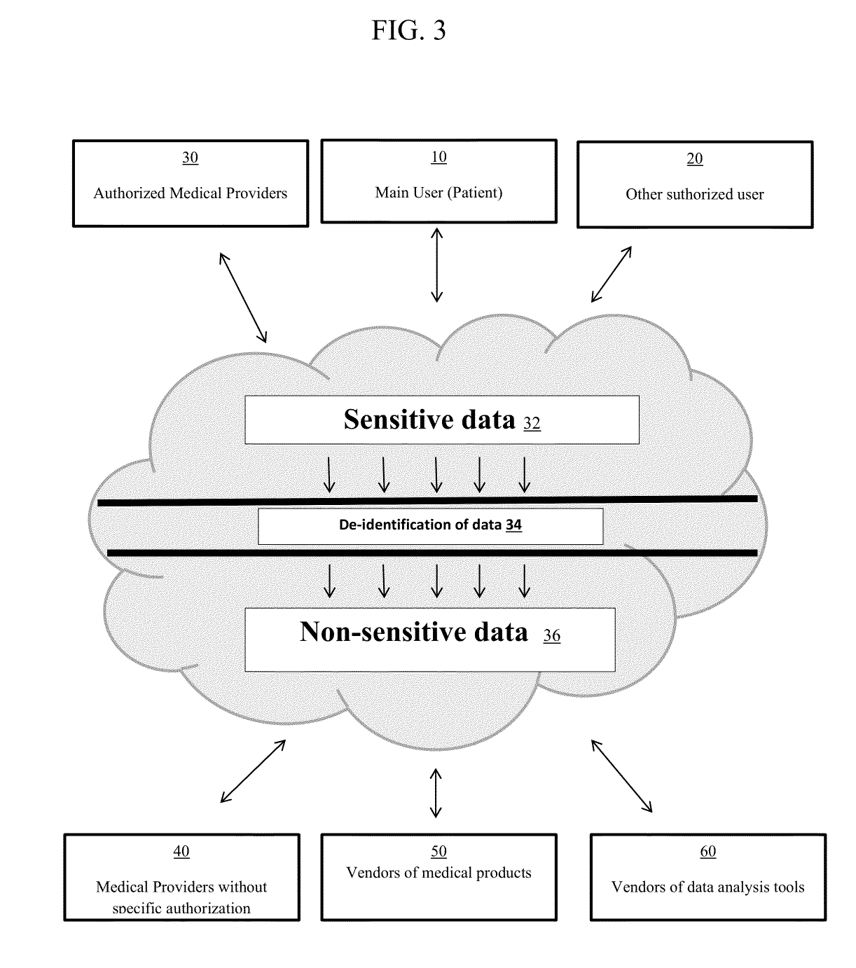

As depicted in FIG. 3, a user may permit his or her sensitive raw data 32 to be de-identified 34 as depicted in FIG. 3. Stripped of any connection with the individual user, such de-identified data 36 may enhance the capabilities of the data analysis tools available to all users of the system.

In embodiments of the invention, third party access of this type, where user-provided ID and password information is transmitted over a network providing third party access to the system, an alert message may be sent to a notification address previously provided by the user. The messages may be of the form of an e-mail, text message, voice message, telephone notification or another form. In this way, the user is advised of who is uploading user medical records, and/or searching or otherwise using a user's medical records.

A second feature of the invention involves a provider information database stored on a computer readable medium containing provider services information uploaded by a health care provider (or an authorized third party) and accessible by the user. Access to the system of the invention by medical providers (and their proxies) distinguishes the present invention from the prior art as a result of the two-way flow of information within the network, providing a means by which medical providers can contact users, advertise their services, render services and engage in transactions with the users.

Sign up for the providers is conducted similarly to sign up for users although a user's medical records data are accessible to the user only through a user interface, and to an authorized provider only through a provider interface, and the interfaces are not identical. However, the system generates login credentials for a medical provider after identity is verified in the same way that the system generates secure login credentials for a user. Likewise, a medical provider may generate or obtain third party login information.

The system according to the invention comprises a communication module enabling conversations between providers and users. This may take the form of messaging within the system. Messaging functionality within a “closed-world” network is known in the social media context and need not be elaborated upon herein.

The system may also include a viewing tool adapted to sort, format and perform statistical analysis on a user's medical records data, so that information from the provider information database is accessible to and searchable by a user. Thus, a provider may perform operations on a user's medical records data in the course of consulting. For example, the provider may highlight areas of interest in the user's images stored in the database, and the provider's comments, highlighting or other manipulation of the user's data may be made visible to the user.

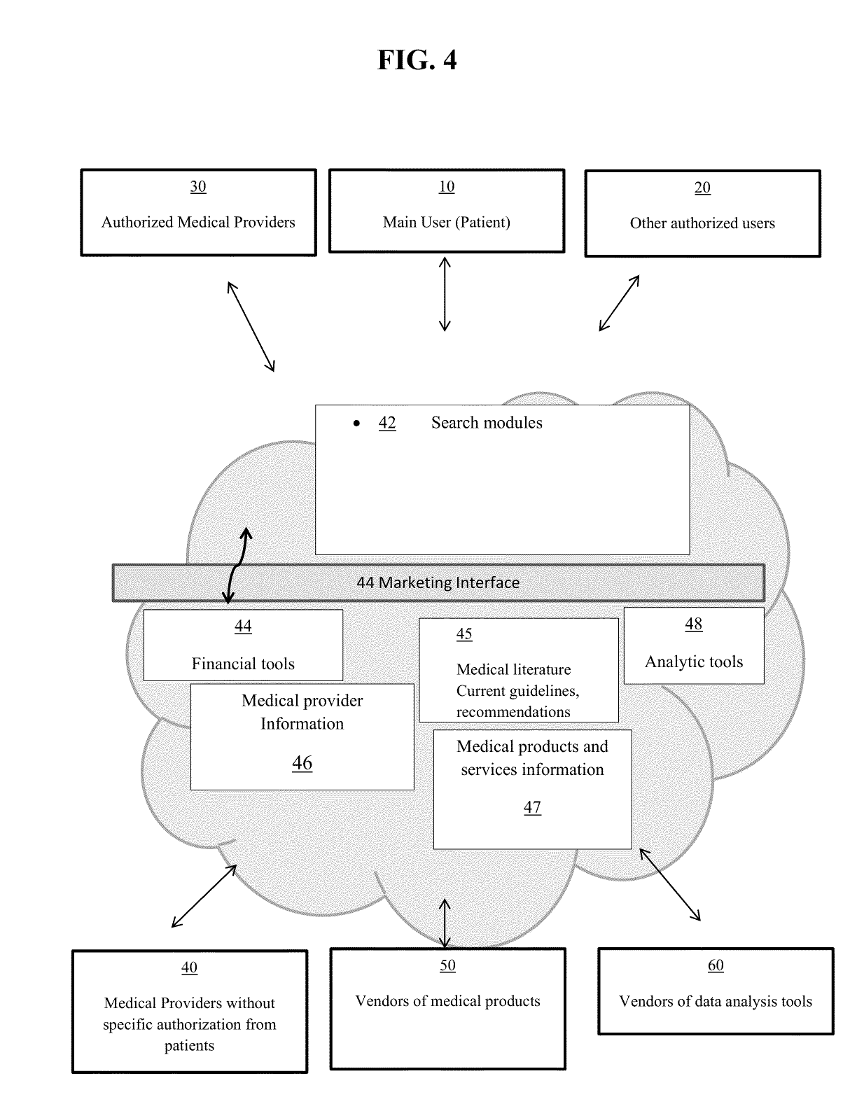

A novel aspect of the invention is the combination of medical marketing, medical records storage and retrieval, medical database searching, and transacting for medical goods and services in a single secure system. This combination results in specific interactions of the user with the system depicted in FIG. 4. For example, an authorized user may initiate a search for medical providers, medical information, medical services or literature (45) in one or more search modules 42. The search module may return result sets that include hyperlinks that the user may access through a marketing interface 44, which allows the user to link financial tools 49 to complete secured transactions directly with providers of goods and services 47. The search results may also display medical provider information 46, with which the user may directly contact the provider through the network, or offline. Analysis tools 48 created, compiled and maintained by vendors 60 may be accessed by the user for free or on a fee-based system. As multiplicity of interactions enabled by the system increases as the number of users increases. With an increase in the number of users, the richness of the data increases. As a result, the search results set are increasingly robust—a phenomenon familiar to the users of social media.

In embodiments, a provider may upload a computer program or system of programs, known as a tool, which the user may use to conduct the user's own analysis of the medical records data in the course of a consultation. The presence of the provider's information in a provider information database uploaded by a health care provider and accessible by the user may be made available to all users, including generic information of general interest, or the provider can make information or tools selectively available to users according to the relationship established between a particular user and provider within the network. Systems for establishing privacy levels within a social network to implement the sharing of information are widely known and need not be elaborated upon herein.

A connection between a user and a provider after consultation, which may include viewing and analysis of the user's medical records stored in the medical records database by both a user and provider, using information and tools available from the provider database, and communication between the user and provider using a communication module, may culminate in a secure commercial transaction between the user and the provider. In this way the user is not required to exit the website to transact for services with the provider, which results in a more streamlined process for the delivery of medical services.

In another aspect, the invention includes a library database of general medical information. The administrator of the system may provide a library services database to supplement the functionality of the network for both users and providers. For example, the library database may include medical information for entire populations, such as normal ranges for various markers and indicators, which a user and/or provider may use for comparison to the user's medical records data. In preferred embodiment, the data in the library database can be accessed by the user, the provider, and also by tools that form part of the network, so that reports may be provided including the user's specific medical records data, together with generally available information.

The above description of preferred embodiments is not to be deemed as limiting the invention, which is defined by the following claims. Variants of the disclosed embodiments which may be practiced within the scope of the invention will be readily apparent to those of skill in the art in light of the foregoing disclosure.

1. A cloud-based medical records management system accessible by users and medical providers, comprising:
a medical records database stored on a computer readable medium containing a user's medical records data uploaded by a user or by a third party authorized by the user;
a provider information database stored on a computer readable medium containing provider services information uploaded by a health care provider and accessible by the user;
an authorization module accessible by a user's computer enabling a user to grant access to the user's medical records data to an authorized provider, and enabling a user to permit third parties to upload a user's medical records data;
a viewing tool adapted to sort, format and perform statistical analysis on a user's medical records data; and
a communication module enabling conversations between providers and users;
wherein the provider information database is accessible to and searchable by a user;
wherein a user's medical records data are accessible to the user through a user interface and to an authorized provider through a provider interface.

2. The cloud-based medical records management system according to claim 1, further comprising a transaction module accessed by a user and a provider permitting a user to contract and pay for provider services.

3. The cloud-based medical records management system according to claim 1, further comprising a provider tool accessible by the user which operates on the user's medical records data as input to produce an output viewable by the user.

4. The cloud-based medical records management system according to claim 1, further comprising a medical records database containing non-user specific medical records data to identify potential consumers of provider services without identifying a user.

5. The cloud-based medical records management system according to claim 4, wherein raw data from a user's medical records data is de-identified to remove information specific to the user.

6. The cloud-medical records management system according to claim 1, further comprising: a data processing module to identify sensitive information to the system and to identify non-sensitive information to the system; and a second data processing module to identify authorized and non-authorized users of the system.

7. The cloud based medical records management system according to claim 1, further comprising a library database of general medical information which can be accessed by the user, the provider, the viewing tool and/or the provider tool.

8. A method for user-controlled medical records management and communication between health care users and health care providers, comprising the following steps performed by a server functionality operating on the cloud:
receiving user medical records data uploaded from a user computing device in a cloud-based user medical records database;
receiving provider services information uploaded from a provider computing device in a cloud-based provider services information database;
receiving authorization information from a user and authorizing access to the user's medical records data to an authorized provider;
performing operations on a user's medical records data and providing a viewable display to the user and an authorized provider;
providing a viewable display of the provider services information to the user and the provider; and
transmitting communications between a provider and a user;
wherein a user's medical records data are accessible to the user through a user interface and to an authorized provider through a provider interface.

9. The method according to claim 8, further comprising receiving and processing payment for services information between a user and a provider.

10. The method according to claim 8, wherein the user accesses a provider tool which operates on the user's medical records data.

11. The method according to claim 8, further comprising a step of removing user-specific data from a user's medical records data and maintaining non-user specific medical records data.

12. The method according to claim 8, further comprising a step of receiving information from a library database of general medical information, accessed by the user, the provider, the viewing tool and/or the provider tool.
